(19) United States
(12) Patent Application Publication
(10) Pub. No.: US 2026/0188063 A1
(43) Pub. Date: Jul. 2, 2026

(54) SYSTEM AND METHOD FOR SECURE DATA CAPTURE

(71) Applicant: Torc Robotics, Inc., Blacksburg, VA (US)

(72) Inventors: William Gray Davis, Austin, TX (US); Akshay Pai Raikar, Austin, TX (US); Makarand Phatak, Austin, TX (US); Joseph R. Fox-Rabinovitz, Austin, TX (US)

(21) Appl. No.: 19/001,888

(22) Filed: Dec. 26, 2024

(51) Int. Cl. G07C 5/08; G07C 5/00; H04L 9/06

(52) U.S. Cl. CPC G07C 5/085; G07C 5/008; H04L 9/0643

(57) ABSTRACT

A system for secure data capture is provided. The system includes sensors associated with a vehicle, and a database configured to electronically store data based on signals received from the one or more sensors. A processing device is configured to execute instructions stored in a memory to perform operations including detecting an event based on the signals received from the one or more sensors, and identifying a starting point of the event, where the starting point is a first predetermined amount of time before the event. The operations include identifying an ending point of the event, where the ending point is a second predetermined amount of time after the event. The operations include electronically storing data representative of an occurrence event, the data including data representative of signals from the starting point to the ending point of the event.

### TECHNICAL FIELD

The field of the disclosure relates to vehicle data capture and, in particular, to a system that securely captures data related to events relating to operation of the vehicle.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

As autonomous vehicles operate and travel along their mission route, various events can occur. For example, accidents around the autonomous vehicle or accidents involving the autonomous vehicle can occur. Due to the autonomous nature of the vehicle, there is limited or no human presence to determine the events that led to the accident and what could be modified to prevent such accidents from occurring in the future.

Accordingly, there exists a need for a system and a method of data capture that accurately detects events and captures relevant data surrounding the detected events for future use. These and other needs are met by the exemplary system for secure data capture discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for secure data capture is provided. The system includes one or more sensors associated with a vehicle, and a database configured to electronically store data based on signals received from the one or more sensors. The system includes a processing device in communication with the one or more sensors and the database. The processing device is configured to execute instructions stored in a memory to perform operations including detecting an event based on the signals received from the one or more sensors, and identifying a starting point of the event. The starting point can be a first predetermined amount of time before the event. The operations include identifying an ending point of the event. The ending point can be a second predetermined amount of time after the event. The operations include electronically storing data representative of an occurrence event, the data including data representative of signals from the starting point to the ending point of the event.

In some embodiments, the vehicle can be an autonomous vehicle. In some embodiments, the one or more sensors can include, e.g., a camera, LIDAR, a microphone, IMU, RADAR, or combinations thereof. The one or more sensors can be configured to detect and capture in real-time the event occurring with the vehicle or around the vehicle.

In some embodiments, the event can be an accident involving the vehicle. In some embodiments, the event can be an accident occurring with another vehicle proximate to the vehicle. In some embodiments, the first predetermined amount of time can be about, e.g., 30 seconds, 20 seconds, 10 seconds, or the like, before the event. In some embodiments, the second predetermined amount time can be about, e.g., 30 seconds, 20 seconds, 10 seconds, or the like, after the event.

In some embodiments, the operations can include transmitting the data representative of the occurrence event to a third party. In some embodiments, the third party can include local authorities. In some embodiments, the event can be detected based on a sharp acceleration or a sharp deceleration of the vehicle. In some embodiments, the term “sharp” for acceleration or deceleration can be equivalent to a jerk value of about, e.g., 3 m/s³ and higher, 5 m/s³ and higher, or the like. In some embodiments, the event can be detected based on performance of the vehicle outside of baseline performance thresholds. The baseline performance thresholds can be determined on a case-by-case basis based on data collected during the driving operation of the vehicle. In some embodiments, the event can be detected based on a sharp angle change of the vehicle relative to a trailer associated with the vehicle. In some embodiments, the term “sharp” for an angle change can be equivalent to about 5 deg/s or greater. In some embodiments, the term “sharp” for an angle change can be, e.g., more than 30 degrees of change in under half a second.

In some embodiments, the data representative of an occurrence event can include metadata associated with the occurrence event. In some embodiments, the operations can include generating a hash file corresponding with the data representative of the occurrence event. The hash file and the data representative of the occurrence event can be electronically stored on different servers. At least one of the hash file or the data representative of the occurrence event can be locked to allow searching and reading but not modification. The hash file can be usable for verification of accuracy of the data representative of the occurrence event.

In another aspect, an exemplary computer-implemented method for secure data capture is provided. The method includes detecting an event based on signals received from one or more sensors associated with a vehicle. The method includes executing instructions stored in a memory with a processing device in communication with the one or more sensors to perform operations. The operations include identifying a starting point of the event. The starting point is a first predetermined amount of time before the event. The operations include identifying an ending point of the event. The ending point is a second predetermined amount of time after the event. The operations include electronically storing data representative of an occurrence event. The data includes data representative of signals from the starting point to the ending point of the event.

In some embodiments, the operations can include generating a hash file corresponding with the data representative of the occurrence event. The hash file can be usable for verification of accuracy of the data representative of the occurrence event.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for secure data capture.

FIG. 7 is a flowchart of a method for secure data capture.

FIG. 8 is a flowchart of a method for secure data capture, including storage of data in a read only format.

FIG. 9 is a flowchart of a method for secure data capture, including creation of a hash file and storage of data in a read only format.

FIG. 10 is a flowchart of a method for secure data capture, including buffer implementation.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As autonomous vehicles travel along their mission route or within hub centers, the sensors associated with the vehicle capture a large amount of data. In general, the data is captured on a continuous or substantially continuous basis. While the data assists the vehicle in operating and moving safely along the intended mission route and within the surrounding environment, the same data can be used to capture events, such as accidents, occurring around or with the vehicle. The exemplary system for secure data capture detects occurrence of an event, such as an accident, based on signals received from the sensors. The system identifies a starting point for the event and an ending point for the event, with these points being offset from the actual event occurrence detected by a predetermined period of time. This allows the occurrence event data to include sensor data for a time before the actual event occurs and for a time after the actual event occurs, providing context to mission control and/or authorities when determining the cause of the event. The system therefore ensures the relevant data is separated from the main data stream for convenient access to review only the applicable information for the event.

In some embodiments, the exemplary system can be used to detect when an accident has occurred around and/or involving the vehicle using the sensors on the vehicle. Detection and tracking of collisions of the vehicle as they occur can be useful for safety and legal reasons. The system offers the ability to record and capture events and their corresponding time stamps preceding and subsequent to the occurrence of an accident involving the vehicle. The accident event can occur with the vehicle, or sensors of the vehicle can be used to capture accidents occurring around the vehicle without any direct involvement of the primary vehicle. For example, secondary vehicles surrounding the primary vehicle can be involved in an accident, and the primary vehicle can use its sensors to capture data relating to the accident. Such data can be used by third parties, e.g., local authorities, to investigate the occurrence of the accident and to determine fault.

The system allows for automatic detection of the exact time of the accident/event for collection and recording the time-stamped sensor data. For an autonomous or semi-autonomous vehicle, having such recorded data can be useful to prove that the vehicle was not at fault in the accident. In some instances, the 30 seconds before the detected event and 30 seconds after the event time stamp can be used as boundaries for removing and storing the occurrence event block from the main data stream or storage, thereby maintaining only the relevant data for the event review/analysis. Knowing the exact accident/event time with a high level of precision is important to alert law enforcement and provide them with information for investigation.

The accident data can be distinguished by whether the autonomous/primary vehicle was involved in a direct collision. As an example, when the vehicle is involved in a collision, this can happen either through the vehicle being rear-ended, a side impact collision, or the vehicle itself crashing into another vehicle or infrastructure. As another example, when the vehicle is not involved in a collision, the system identifies and detects an accident that has occurred among other vehicles and/or traffic actors. The primary vehicle includes a variety of sensors that continuously or substantially continuously capture data, such as, e.g., cameras, LIDAR, IMU, RADAR, or the like. The system can use the data collected and processed to determine a collision event occurring, and then ascertains the time stamp for the accident event with a high level of accuracy. This enables the system to record the sensor data preceding and after the event. For example, as noted above, 30 seconds of data before and after the detected event could be used to ensure proper context before the detected event is provided by the sensor data. In some embodiments, the before and after event data can be used to justify why the vehicle was unable to avoid a collision.

For instances where the primary vehicle is in a collision, the system can use the vehicle IMU data. Such data can be compared to typical or expected operational thresholds for the vehicle as the vehicle travels along the intended route. Discrepancies between the expected operational/performance thresholds and the detected operation can be indicative of an accident occurrence or abnormal events. For example, the acceleration data can be used to identify signal patterns representing an accident. Typically, this would be a sharp increase in acceleration in a direction opposite to the accident. In some instances, sharp deceleration can similarly be used. Camera data can be used to ascertain if the vehicle has been struck by another vehicle, object or individual. LIDAR cloud data can be used observe and detect the collision of the vehicle with other objects in its vicinity based on depth thresholds. Sharp, sudden changes in trailer angle may be indicative of a side collision with the trailer of the truck. A range of signals from the base truck platform can be used to provide further indications of an event occurrence. If brakes fail or there is a sudden loss of acceleration, this can be indicative of an accident occurrence.

For instances where the primary vehicle is not in a collision and surrounding vehicles are observed in the event occurrence, the camera data and internal system health monitor signals/faults can be used. For example, camera data can be used to detect collision of other vehicles in the environment. Operational data from the primary vehicle, such as sharp acceleration or sharp deceleration, can be indicative of the primary vehicle avoiding a collision with a secondary vehicle, but the secondary vehicle still collides with other vehicles and/or objects. In some embodiments, center mount high stop lamps (CMHSL) on the vehicle can be used to indicate an accident based on flashing of the lamps. (See, e.g., https://www.nhtsa.gov/sites/nhtsa.gov/files/documents/chmsl_complete.pdf). The CMHSL lamps can be programmed to flash continuously as a distress signal in the event of a crash/accident. These signals are a representative subset of the rest of the signals within the vehicle, and flashing of the lamps can be used as an indication of a time stamp for occurrence of an accident. The time stamp can be subsequently used by the system to isolate and store the sensor data before and after the detected event (e.g., 30 seconds before and 30 seconds after) for independent triage and/or investigation.

In some instances, when data from sensors on the vehicle is stored for purposes of proving liability or fault relating to detected accident events, the validity of such data may be questioned. For example, when the data is to be used for legal purposes, accusations of tampering with the data may occur since such data is typically solely under the control of the company controlling the vehicle. The exemplary system provides a data storage means which can be managed by a trusted third party, e.g., local enforcement, the government, or the like, which provides some measure of defense against such accusations.

The system can therefore include a remote data storage application programming interface (API) that receives all data from a vehicle (or other entity with similar recording requirements/abilities) in a manner that only allows the data to be read once it is received. In particular, the data captured and selected as representative of a detected event can be stored in a read only format as proof that tampering of the data has not occurred. For example, the vehicle can be involved in an accident and the system cuts or separates a portion of the data surrounding the detected accident event. Such data can be, e.g., two minutes of data, stored in a special buffer to report and share during an investigation. The vehicle or mission control can report to a third party API that new event data has been captured. The API can allocate storage for the new data and sends connection information to the vehicle or mission control.

The data and metadata can be uploaded sequentially (e.g., as a stream with no random access allowed). The vehicle or mission control can notify the API that the transmission of data is complete, and the API can close off and catalogs the record. The record can be searched and read by parties in a secure manner, but cannot be modified without a court order. By using a trusted third party, the possibility of data being tampered with by stakeholders in an accident, including law enforcement, is eliminated. Layers of isolation between the facility management and software for the system provide additional guarantees that neither the people involved in maintaining the software nor the physical infrastructure can tamper with the data once it has been recorded.

In some embodiments, as another measure of defense against accusations of tampering with stored data, the system can store hashing values associated with the stored data to further support legitimacy of the data. Similar to the example above of a vehicle involved in an accident and the vehicle reporting the new event to the third party API, the vehicle can hash the data using a hashing algorithm, such as (but not limited to) the commonly used SHA-256 algorithm. The vehicle or mission control can upload the data hash and metadata to the API location and notifies the API that the transfer is complete. The API can close off and catalogs the record, which can be searched and read, but cannot be modified without a court order. By using a trusted third party to store the hashed data, if doubts are raised about legitimacy of the data in the future, the hashed data can be used to support the originality and accuracy of the main data file. The hashed data requires less storage space from the third party API and can be used to verify that the original event data has not been modified. In some instances, the third party API can store the original event data and the hashed data can be stored with mission control to minimize storage.

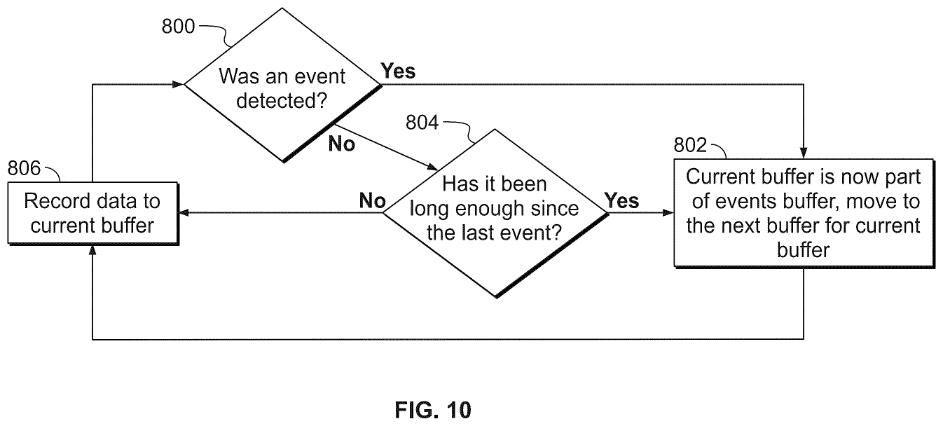

In some instances, the storage space may be limited on the vehicle or at mission control. The system can provide means for compiling the legally interesting portions of the drive onto a fixed-size system, backs up the data, and triages drive for space if/as necessary (see, e.g., FIG. 10). The system can include a number of fixed-sized buffers, each of which is large enough to hold, e.g., two minutes of data. The number/size of data can be any mount, bounded by available capacity and 3-sigma probability of encountering a type 2 event. The duration of the vehicle trip may not affect the choice since the probability of encountering an event increases linearly in time, as does the amount of storage required for the trip data. The “current” buffer can be used to store a live copy of the last two minutes of logged data. The moment an accident is detected, the current counter can be incremented and prior data can be fixed in what is referred to as the “previous” buffer. In particular, the “current” buffer in which the accident is detected can be converted and referred to as the “previous” buffer, and the system can switch to a new “current” buffer for continued storage. No gap is induced by switching buffers, since accidents can be detected in quick succession.

Buffers shorter than two minutes from the previous event store a reference to the buffer containing the prior two minutes of data. When the buffer count increments, the system can run two processed on the prior data. First, the system sends the buffer to external storage, e.g., mission control, law enforcement, any external storage service, or the like. The transmission can be in real time, or may be as a backlog. Next, triage is used to determine a priority number based on hierarchical factors such as, e.g., is the vehicle involved (if yes, top priority and perform minimal risk maneuver (MRM)), how sever is damage to involved persons, how sever is property damage, or the like. The system can send a query to local law enforcement, either directly or through mission control. If feedback is received, the system can use this feedback information to adjust the priority number. Priority numbers can be ignored until all of the buffers are filed. Once this happens, the system can overwrite the buffer with the lowest priority number. The system can therefore maintain a dedicated location for legal and forensic evidence in a special location that will be treated similarly to an aircraft black box, even when the remainder of the system may be destroyed. Limited buffers on the vehicle can therefore be used, with prioritization of overwrite locations.

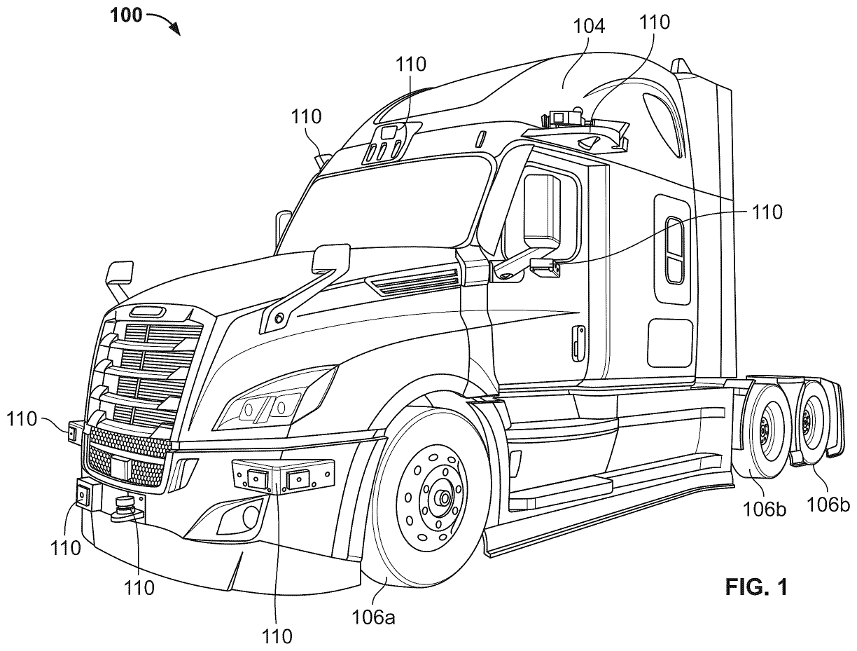

Various embodiments in the present disclosure are described with reference to FIGS. 1-9 below.

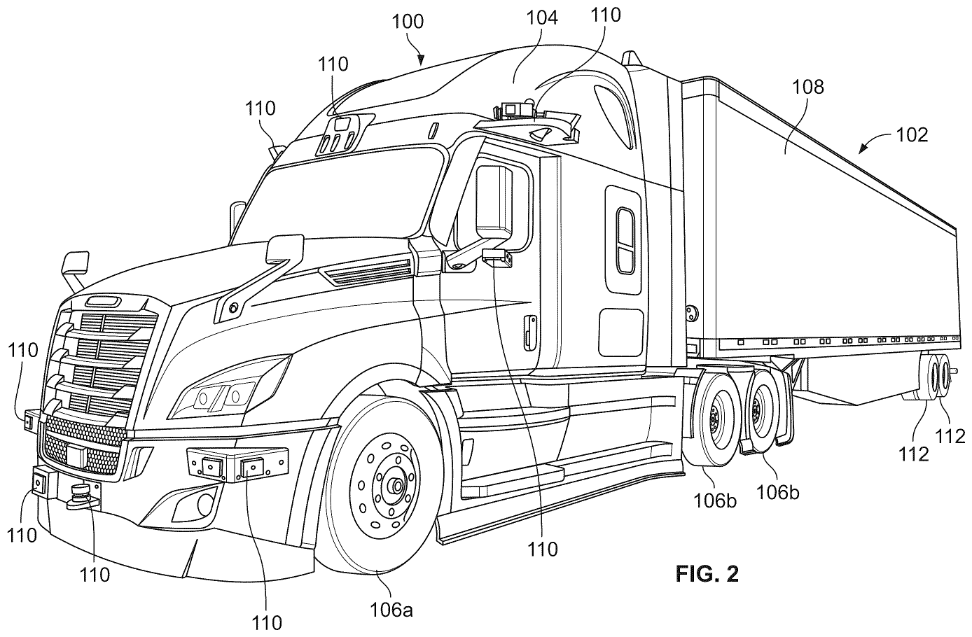

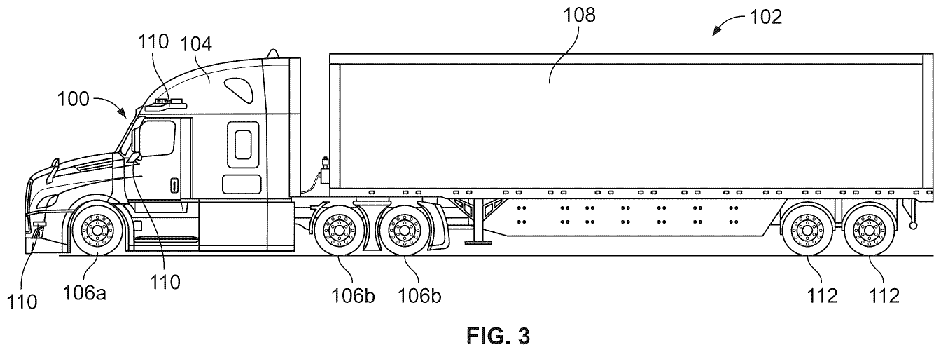

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

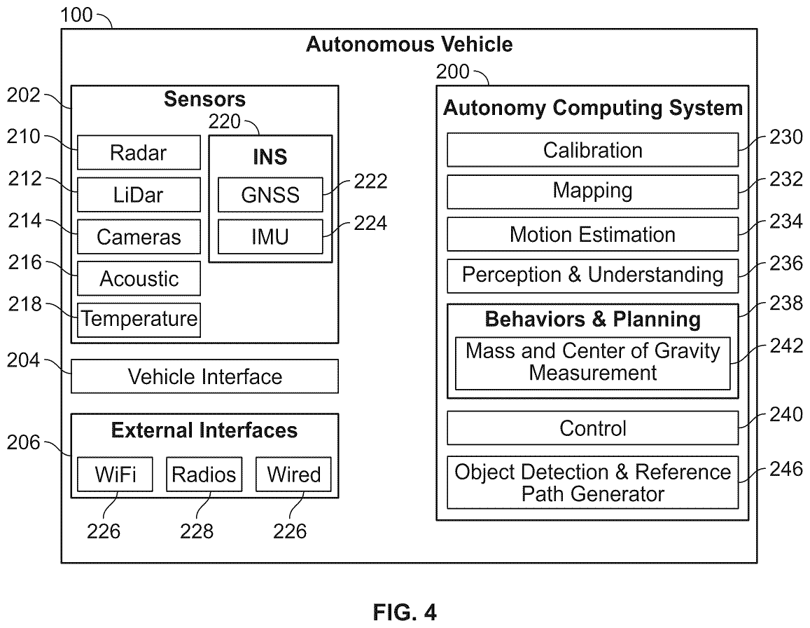

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

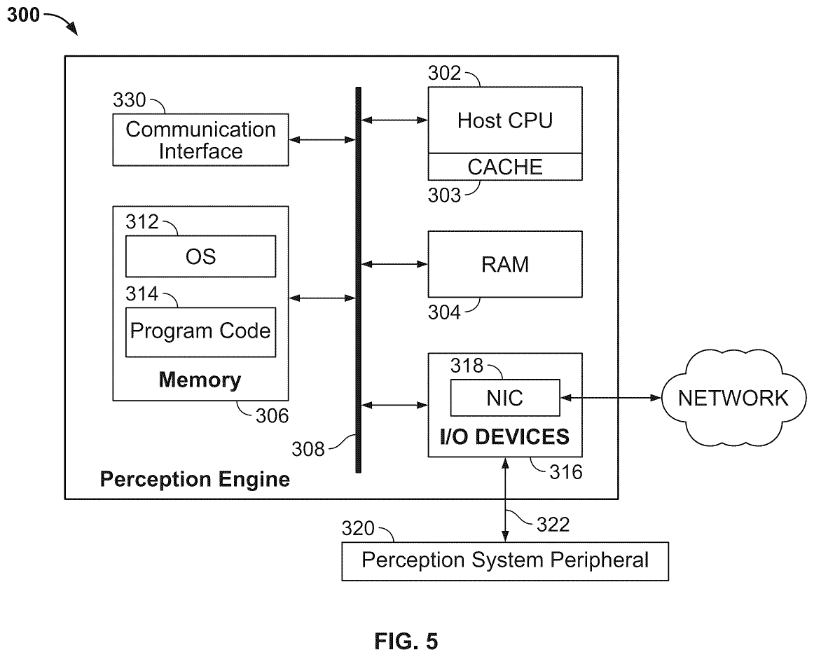

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

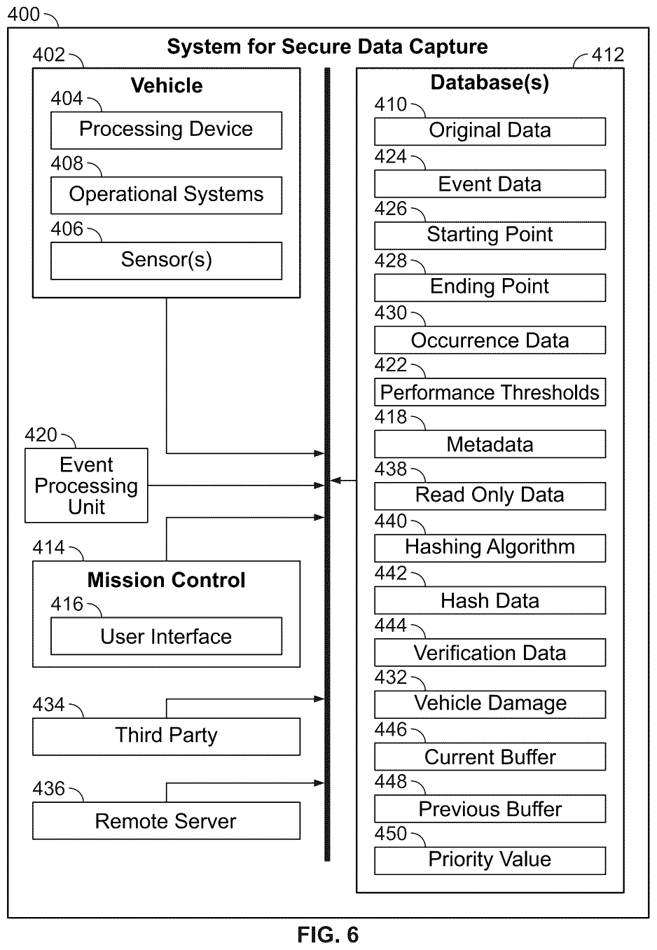

FIG. 6 is a block diagram of an exemplary system 400 for secure data capture. The system 400 generally includes one or more vehicles 402 (e.g., autonomous vehicle 100). Each vehicle 402 includes a processing device 404 (e.g., computing system 200, computing system 300, or the like) configured to receive and process data relating to events detected by the system 400 (e.g., sensors of the vehicle 402). In some embodiments, at least some of the data received by the processing device 404 can be data from one or more sensors 406 (e.g., sensors 202). For example, the sensors 406 can detect operational performance of the vehicle 402 (e.g., via operational system 408 characteristics) and/or visual detection of occurrences (e.g., accidents) relating to the vehicle 402 or with surrounding vehicles and/or objects. The characteristics detected for the operational system 408 can include the following non-limiting examples: unexpected or fast rate of acceleration, unexpected or fast rate of deceleration, unexpected or sharp angle of turning, unexpected or sharp movement of trailer relative to vehicle 402, increased vibrations from a collision, combinations thereof, or the like.

As the vehicle 402 travels along its route, e.g., the mission route, the sensors 406 detect the operational performance of the vehicle 402 and/or occurrences in the field-of-view of the sensors 406. Such collection of data from the sensors 406 can be performed continuously or substantially continuously in real-time, and the data can be stored as original data 410 in a database 412 in communication with the vehicle 402. The database 412 can be located on the vehicle 402, or can be stored remotely from the vehicle 402. In some embodiments, the database 412 can be associated with a mission control 414 in communication with the vehicle 402. A user interface 416 of the mission control 414 can be used to input and/or visualize data stored in the database 412. The original data 410 can include metadata 418 associated and stored in the database 412, including, e.g., location, time, date, or the like, for each data sample.

An event processing unit 420 can be in communication with the database 412, the vehicle 402 and/or mission control 414. As data 410 is collected by the system 400, the unit 420 can analyze the data 410 and determine if an event has been detected by the sensors 406. In particular, the unit 420 can analyze the signals from the sensors 406 to determine if abnormal operating characteristics have been detected for the vehicle 402, the trailer associated for the vehicle 402, or visually via field-of-view detection of the sensors 406. For example, the system 400 can store performance thresholds 422 for the vehicle 402, which can include baseline operational speeds, turning radius, acceleration, deceleration, or the like, for the vehicle 402. The performance thresholds 422 can be based on the planned mission route and the expected performance or operation of the vehicle 402 along the route. If a sudden, unexpected deviation occurs from these performance thresholds 422, such as a sudden acceleration or deceleration, such data can be indicative of a detected event, e.g., an accident. This label of a detected event can be reinforced/corroborated by images or video from cameras used by the vehicle 402, which can show a near miss event or a collision with another vehicle, object and/or human. In some embodiments, the event occurrence can be detected based on only images or video from the cameras without an alteration in the operational performance, e.g., detected vehicle damage 432.

Upon detection of the event occurrence, the unit 420 can extract or cut the data associated with the timeframe of the abnormal operating characteristics, saving this extracted data as the event data 424. For example, if unexpected or sudden deceleration is detected as the initial abnormal performance, followed by a series of additional abnormal performances by the vehicle 402, the event data 424 can include all of the data during which the abnormal performances have been detected. Once the metadata and timestamps for the event data 424 can been determined, the unit 420 can extract from the original data 410 a predetermined amount of time for data before the event data 424, e.g., starting point 426 data, and a predetermined amount of time for data after the event data 424, e.g., ending point 428 data. For example, the unit 420 can extract 30 seconds worth of data from the original data 410 immediately before the event data 424 occurs, and 30 seconds worth of data from the original data 410 immediately after the event data 424 occurs. The compiled data can be representative of occurrence data 430. Although different timeframes before and after the event data 424 can be used, it is understood that the system 400 is configured to capture and extract data around the actual occurrence of the event to provide context for why the event, e.g., accident, may have occurred.

In some embodiments, the system 400 can store data using a buffer system that reduces the amount of storage space needed for operation. For example, the system 400 can store the original data 410 in fixed-size buffers originally labeled as current buffer 446. For example, the current buffer 446 can be used to store a live copy of the last two minutes of logged data from the sensors 406. As soon as an event occurrence is detected by the system 400, the current buffer 446 can be fixed as stored data in a previous buffer 448 to ensure that the captured event data is not deleted or lost. The system 400 can simultaneously convert the current buffer 446 to the previous buffer 448, and begin a new current buffer 446 for capture of live data. If the event occurrences are still detected from the sensors 406, the subsequent current buffer 446 can be converted to a previous buffer 448 and tacked on or saved with the previous current buffer 446 to ensure all event-related data is stored together in the occurrence data 430. A priority value 450 can be associated with the captured data for the event depending on hierarchical factors, such as if the vehicle 402 is involved, how severe the damage is to involved persons, how severe the property damage is, or the like. For example, if the vehicle 402 is involved, this can indicate a high priority value, which results in faster transmission of the data to mission control 414 and/or third parties 434. If the priority value 450 is low, transmission of the data can be delayed until the system 400 is capable of transmitting the data.

In some embodiments, the occurrence data 430 can be stored on the database 412 as reference for, e.g., mission control 414 to determine why an accident occurred, law enforcement to complete an investigation for the accident, or the like. In some embodiments, the occurrence data 430 can be transmitted and stored by a third party 434 (e.g., third party API) and/or on a remote server 436 separate from mission control 414. For example, the data 430 can be transmitted to other locations for storage to ensure the data 430 is not tampered with before being reviewed by law enforcement for an investigation. In some embodiments, the unit 420 can transform the occurrence data 430 into a real only data 438 format for storage either on the database 412, or by the third party 434 and/or remote server 436. The read only data 438 can be searched and viewed, but cannot be modified without a court order.

In some embodiments, the unit 420 can execute a hashing algorithm 440 to generate hash data 442 associated with the occurrence data 430. In some embodiments, the hashing algorithm 440 can be, e.g., a SHA-256 algorithm. The hash data 442 requires less room for storage, but can be used to verify the accuracy of occurrence data 430 (e.g., by determining if a match between the occurrence data 430 and hash data 442 exists). The hash data 442 and/or the occurrence data 430 can be stored at the third party 434 and/or remote server 436, and can serve as proof of originality and lack of modification of the occurrence data 430. This can show lack of tampering with the data for an investigation. In such embodiments, the hash data 442 can be compared to the occurrence data 430 to indicate whether the occurrence data 430 has been modified, and verification data 444 can be generated by the system 400 to indicate if tampering with the data has occurred.

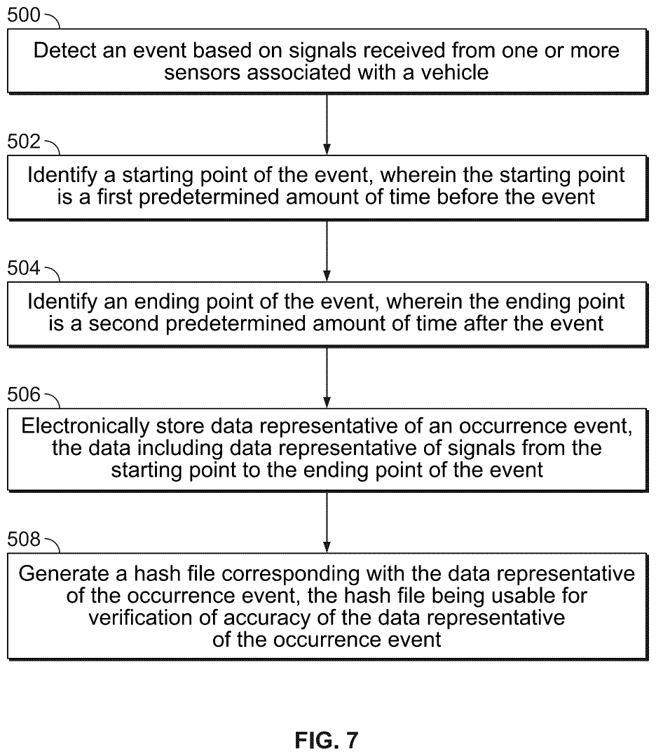

FIG. 7 is a flowchart of a method of secure data storage performed by the system 400, including identification of an event occurrence, saving data before and after the event occurrence, and (optionally) creating a hash data file corresponding with the event occurrence data. At 500, the system detects an event based on signals received from sensors associated with the vehicle. Such signals can be representative of performance of the vehicle itself, and/or detected objects/vehicles/individuals around the vehicle. At 502, the system identifies a starting point of the event, which is a predetermined amount of time before the actual event occurrence. This allows for identification of events immediately before the detected event occurred, e.g., for clarification of why a near miss or accident occurred. At 504, the system identifies an ending point of the event, which is a predetermined amount of time after the actual event occurrence. This allows for identification of events immediately after the detected event occurred, e.g., for clarification of what actions were taken after the near miss or accident.

At 506, data representative of the occurrence event is electronically stored in a database associated with the system. The data includes all signals from the starting point to the ending point of the event, such that the entire timeframe of the actual event and the time periods before and after the event. This data can be subsequently used by mission control and/or law enforcement to determine if an accident occurred and the fault/liabilities of the parties involved. In some embodiments, at 508, the system can generate a hash file corresponding with the data representative of the occurrence event. The hash file can be used for verification of accuracy of the data representative of the occurrence event. In some embodiments, the hash file and/or the occurrence event data can be transmitted for storage to a third party for reference. When the occurrence event data is to be reviewed for determination of fault/liabilities, the hash file can be used to verify the accuracy and reliability of the occurrence event data, i.e., that no tampering of the data occurred.

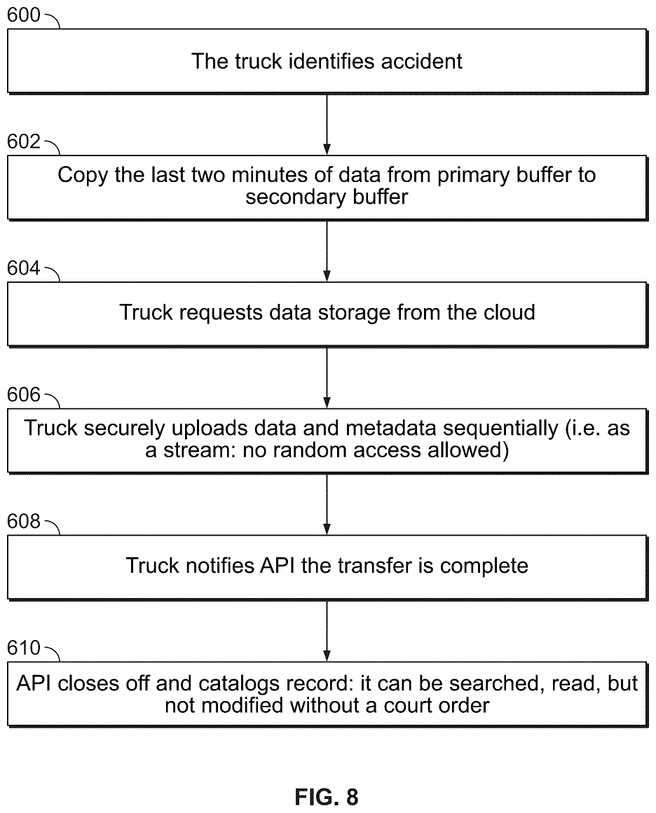

FIG. 8 is a flowchart of a method of secure data storage performed by the system 400, including transfer of the event occurrence data to a third party API. At 600, the vehicle identifies that an accident has occurred based on signals received from the sensors associated with the vehicle At 602, the last two minutes of data from a primary buffer (e.g., a current buffer) can be copied to a secondary buffer (e.g., a previous buffer) to ensure permanent storage of the event-related data. At 604, the vehicle can request data transfer and storage from the cloud. For example, the request can be to transmit and store the event-related data to a database owned by the company associated with the vehicle, a third party server, law enforcement, or the like.

At 606, the vehicle securely uploads data and metadata sequentially to the database(s), ensuring that all event-related data is stored in an accessible manner. In some embodiments, the data can be uploaded and stored as a stream. In some embodiments, the data can be uploaded and stored as random access allowed (e.g., read only). This ensures that the data can be securely stored without tampering. At 608, the vehicle can notify the API that the transfer is complete. At 610, the API can close off and catalogs the record for future viewing/reference. The record can be searched and read, but cannot be modified without a court order. This ensures reliability of the data for use by mission control and/or law enforcement in performing an investigation.

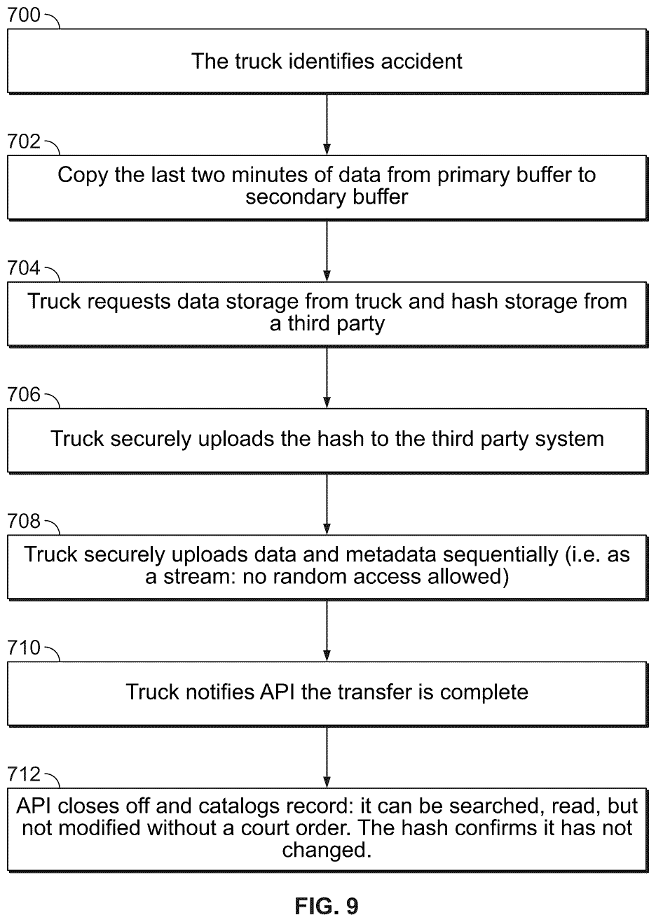

FIG. 9 is a flowchart of a method of secure data storage performed by the system 400, including creation of hash data for verification of the stored event occurrence data. At 700, the vehicle identifies occurrence of an accident based on signals from sensors associated with the vehicle. At 702, the last two minutes of data from the primary buffer are copies to the secondary buffer. At 704, the vehicle requests data storage from the vehicle (and/or mission control) and hash storage from a third party system (e.g., a third party API). At 706, the vehicle securely uploads the hash data to the third party system.

At 708, the vehicle securely uploads the data and metadata sequentially (e.g., as a stream, no random access allowed). At 710, the vehicle notifies the API that transfer of data is complete. At 712, the API closes off and catalogs the record. The data can be searched and read, but cannot be modified without a court order. The hash data can be used to confirm that the stored data has not been changed/modified, ensuring reliability of the data for future review and/or investigation. The system therefore provides for advantageous means of capturing and storing data in an efficient and reliable manner.

FIG. 10 is a flowchart of a method for secure data capture performed by the system 400, including a buffer implementation. At 800, a determination is made whether an event has been detected. If yes, at 802, the current buffer is made part of the events buffer, and the next buffer is moved to the current buffer. For example, the current buffer can be used to store a live copy of the last two minutes of the logged data. The moment an event is detected (e.g., an accident), the current counter can be incremented and prior data can be fixed in what is referred to as the previous buffer. In particular, the current buffer in which the event is detected is converted and referred to as the previous buffer, and the system switches to a new current buffer for continued storage. If at 800 an event has not been detected, at 804, the system can determine the period of time since the last event has been detected relative to a threshold value. If the threshold recording time period has not been reached, at 806, the system can continue recording data to the current buffer. If the threshold recording time period has been reached, the steps at 802 are performed to convert the current buffer to the previous buffer, and the new current buffer is initiated.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for secure data capture, comprising:
one or more sensors associated with a vehicle;
a database configured to electronically store data based on signals received from the one or more sensors; and
a processing device in communication with the one or more sensors and the database, wherein the processing device is configured to execute instructions stored in a memory to perform operations comprising:
detecting an event based on the signals received from the one or more sensors;
identifying a starting point of the event, wherein the starting point is a first predetermined amount of time before the event;
identifying an ending point of the event, wherein the ending point is a second predetermined amount of time after the event; and
electronically storing data representative of an occurrence event, the data including data representative of signals from the starting point to the ending point of the event.

2. The system of claim 1, wherein the vehicle is an autonomous vehicle.

3. The system of claim 1, wherein the one or more sensors include a camera, LIDAR, a microphone, IMU, or RADAR.

4. The system of claim 1, wherein the one or more sensors are configured to detect and capture in real-time the event occurring with the vehicle or around the vehicle.

5. The system of claim 1, wherein the event is an accident involving the vehicle.

6. The system of claim 1, wherein the event is an accident occurring with another vehicle proximate to the vehicle.

7. The system of claim 1, wherein the first predetermined amount of time is 30 seconds before the event.

8. The system of claim 1, wherein the second predetermined amount time is 30 seconds after the event.

9. The system of claim 1, wherein the operations include transmitting the data representative of the occurrence event to a third party.

10. The system of claim 9, wherein the third party includes local authorities.

11. The system of claim 1, wherein the event is detected based on a sharp acceleration or a sharp deceleration of the vehicle.

12. The system of claim 1, wherein the event is detected based on performance of the vehicle outside of baseline performance thresholds.

13. The system of claim 1, wherein the event is detected based on a sharp angle change of the vehicle relative to a trailer associated with the vehicle.

14. The system of claim 1, wherein the data representative of an occurrence event includes metadata associated with the occurrence event.

15. The system of claim 1, wherein the operations comprise generating a hash file corresponding with the data representative of the occurrence event.

16. The system of claim 15, wherein the hash file and the data representative of the occurrence event are electronically stored on different servers.

17. The system of claim 15, wherein at least one of the hash file or the data representative of the occurrence event is locked to allow searching and reading but not modification.

18. The system of claim 15, wherein the hash file is usable for verification of accuracy of the data representative of the occurrence event.

19. A computer-implemented method for secure data capture, comprising:
detecting an event based on signals received from one or more sensors associated with a vehicle; and
executing instructions stored in a memory with a processing device in communication with the one or more sensors to perform operations comprising:
identifying a starting point of the event, wherein the starting point is a first predetermined amount of time before the event;
identifying an ending point of the event, wherein the ending point is a second predetermined amount of time after the event; and
electronically storing data representative of an occurrence event, the data including data representative of signals from the starting point to the ending point of the event.

20. The method of claim 19, wherein the operations comprise generating a hash file corresponding with the data representative of the occurrence event, wherein the hash file is usable for verification of accuracy of the data representative of the occurrence event.
